(19) United States
(12) Patent Application Publication
(10) Pub. No.: US 2006/0145114 A1
(43) Pub. Date: Jul. 6, 2006

(54) Nozzle of pump for bicycle

(76) Inventor: Scott Wu, Wu Feng Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/028,016

(22) Filed: Jan. 3, 2005

(51) Int. Cl. F16K 31/44

(52) U.S. Cl. 251/263

(57) ABSTRACT

A nozzle includes a shell including a first passage, a second passage communicated with the first passage and an aperture communicated with the first passage. A valve is movable in the second passage between a blocking position for blocking the communication between the first and second passages and an opening position for allowing the communication between the first and second passages. The valve includes a reduced end extending into the aperture through the first passage. A controlling device is movable in the aperture between a first position corresponding to the blocking position and a second position for driving the valve by the reduced end to the opening position.

### BACKGROUND OF INVENTION

1. Field of Invention

The present invention relates to a bicycle and, more particularly, to a nozzle of a pump for a tubeless tire of a bicycle.

2. Related Prior Art

According to Taiwanese Patent Publication M242588, a conventional pump 10 includes a cylinder 11, a rod 20, a handle 22, a pipe 40 and a nozzle 50. The cylinder 11 includes a first end connected with a collar 14 and second end installed on the base 12. The rod 20 includes an end connected with the handle 22 and another end connected with a piston (not shown) movably put in the cylinder 11. The pipe 40 includes an end connected with the nozzle 50 and another end connected with the cylinder 11. The nozzle 50 can be engaged with a valve. A switch 65 is installed on the second end of the cylinder 11 in order to control pressurized air flowing to the nozzle 50 from the pump 10 through the pipe 40. The pressurized air flows from the cylinder 11 when its pressure reaches a limit. However, this pump 10 cannot pump a tubeless tire the first time after it is installed on a rim of a bicycle. When the tubeless tire is installed on the rim, the former does not abut the latter tightly. That is, an air-tight space is not defined between the tubeless tire and the rim. Air must flow into the tubeless tire at a high rate under a high pressure in order to push the tubeless tire against the rim tightly so that an air-tight space is defined between the tubeless tire and the rim. That is, the pressure must build in the cylinder before the air is allowed to flow into the tubeless tire from the cylinder.

The present invention is therefore intended to obviate or at least alleviate the problems encountered in prior art.

### SUMMARY OF INVENTION

According to the present invention, a nozzle includes a shell including a first passage, a second passage communicated with the first passage and an aperture communicated with the first passage. A valve is movable in the second passage between a blocking position for blocking the communication between the first and second passages and an opening position for allowing the communication between the first and second passages. The valve includes a reduced end extending into the aperture through the first passage. A controlling device is movable in the aperture between a first position corresponding to the blocking position and a second position for driving the valve by the reduced end to the opening position.

The primary advantage of the nozzle of the present invention is that it can be used for pumping a tubeless tire the first time after it is installed on a rim of a bicycle.

Other objects, advantages, and novel features of the invention will become more apparent from the following detailed description when taken in conjunction with the drawings.

### BRIEF DESCRIPTION OF DRAWINGS

The present invention will be described through detailed illustration of embodiments referring to the drawings.

FIG. 1 is a perspective view of a nozzle according to a first embodiment of the present invention.

FIG. 2 is an exploded view of the nozzle shown in FIG. 1.

FIG. 3 is a cross-sectional view of the nozzle shown in FIG. 1.

FIG. 4 is similar to FIG. 3 but shows the nozzle in an opening position.

FIG. 5 is a perspective view of a nozzle according to a second embodiment of the present invention.

FIG. 6 is an exploded view of the nozzle shown in FIG. 5.

FIG. 7 is a cross-sectional view of the nozzle shown in FIG. 5.

FIG. 8 is similar to FIG. 7 but shows the nozzle in an opening position.

### DETAILED DESCRIPTION OF EMBODIMENTS

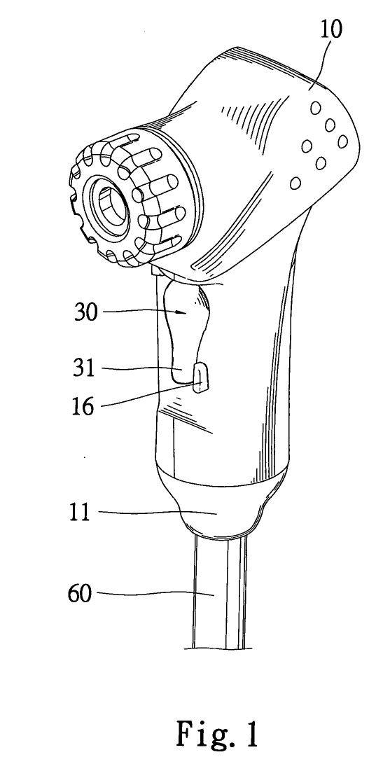

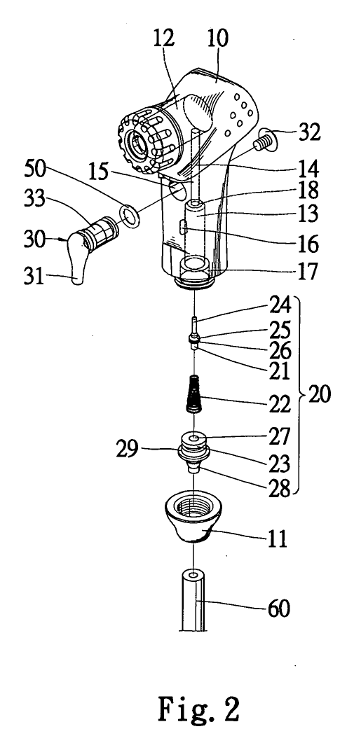

Referring to FIGS. 1 and 2, according to a first embodiment of the present invention, a nozzle includes a shell 10, a valve assembly 20, and a controlling device 30.

The shell 10 includes a passage 12, a passage 14 communicated with the passage 12, a passage 13 communicated with the passage 14, a passage 17 communicated with the passage 13 and an aperture 15 communicated with the first passage 14. The passage 12 extends perpendicular to the passage 14 in this embodiment; however, the passage 12 can extend in parallel to the passage 14. The passage 14 is thinner than the passage 13 so that a shoulder 18 is formed between the first passage 14 and the second passage 13.

The valve assembly 20 includes a valve 25, a spring 22 and a joint 23. The valve 25 is movable in the passage 13. The valve 25 includes a reduced end 24 extending from an end and a reduced end 21 extending from an opposite end. A seal 26 is installed on the valve 25. The valve 25 is used for abutment against the shoulder 18 so as to block the passage 13 from the passage 14. The reduced end 24 is inserted into the aperture 15 through the passage 14.

The controlling device 30 includes a cam 33 rotationally put in the aperture 15 for contact with the reduced end 24 and a lever 31 extending from the cam 33 for facilitating the rotation of the cam 33. A screw 32 is driven into the cam 33 in order to keep the cam 33 in the aperture 15.

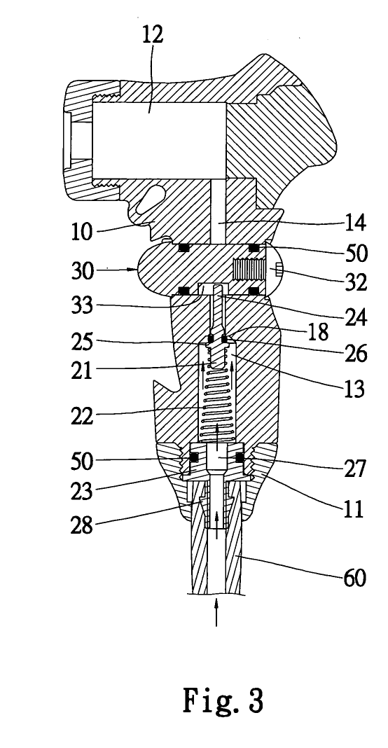

The joint 23 includes an annular flange 29 extending thereabout and a reduced end 28. A passage 27 extends through the joint 23. The joint 23 is put in the passage 17. The annular flange 29 is abutted against an end of the shell 10. The reduced end 28 is inserted in a pipe 60 leading to a pump. A seal 50 (see FIG. 3) is installed on the joint 23.

A spring 22 is put between the valve 25 and the joint 23. The spring 22 includes an end installed on the reduced end 21 of the valve 25 and an opposite end abutted against the joint 23. Thus, the spring 22 tends to push the valve 25 to a blocking position from an opening position.

A cover 11 is used for keeping the joint 23, the spring 22 and the valve 25 in the shell 10.

FIG. 3 shows the nozzle in a blocking position. The seal 26 installed on the valve 25 abuts against the shoulder 18, thus blocking the passage 13 from the passage 14.

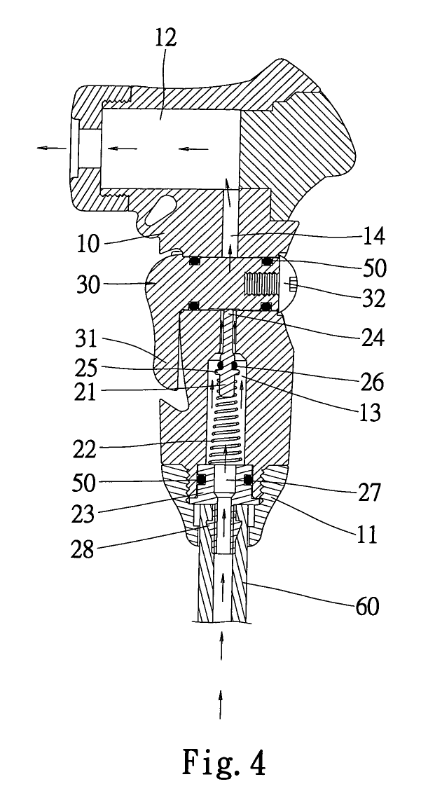

The controlling device 30 can be operated in order to move the nozzle to an opening position shown in FIG. 4 from the blocking position. To this end, the lever 31 is pivoted. The cam 33 is rotated in order to push the reduced end 24. Accordingly, the seal 26 is pushed from the shoulder 18, thus allowing the communication between the passages 14 and 13.

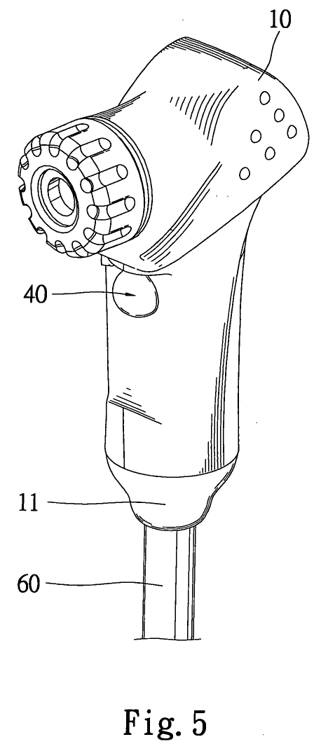

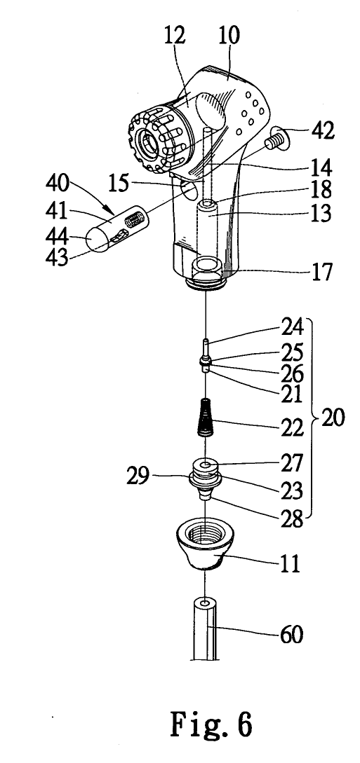

FIGS. 5 and 6 show a nozzle according to a second embodiment of the present invention. The second embodiment is identical to the first embodiment except for several things. Firstly, a controlling device 40 is used instead of the controlling device 30. Secondly, the controlling device 40 includes a rod 41 rectilinearly movable in the aperture 15, a slope 43 formed on the rod 41 for contact with the reduced end 24 and a button 44 is formed at an end of the rod 41. A screw 42 is driven into an opposite end of the rod 41 in order to keep the controlling device 40 in the aperture 15.

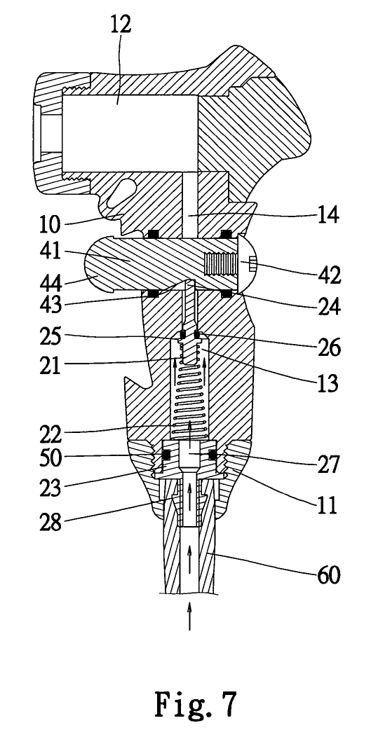

FIG. 7 shows the nozzle in a blocking position. The seal 26 installed on the valve 25 abuts against the shoulder 18, thus blocking the second passage 13 from the first passage 14.

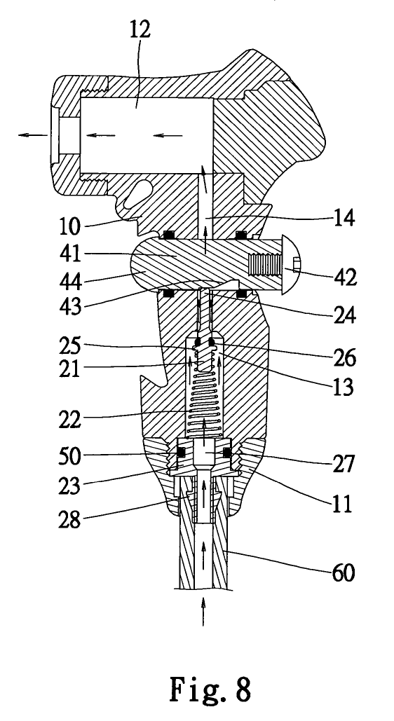

The controlling 30 can be operated in order to move the nozzle to an opening position shown in FIG. 8 from the blocking position. To this end, the button 44 is pushed. The slope 43 is moved in order to push the reduced end 24. Accordingly, the seal 26 is pushed from the shoulder 18, thus allowing the communication between the passages 14 and 13.

The nozzle according to the present invention is useful for pumping a tube of a tire. It is particularly useful for pumping a tubeless tire the first time after it is installed on a rim of a bicycle. When the tubeless tire is installed on the rim, the former does not abut the latter tightly. An air-tight space is not defined between the tubeless tire and the rim. Air must flow into the tubeless tire at a high rate under a high pressure in order to push the tubeless tire against the rim tightly. To this end, the nozzle is put in the blocking position while the pump is operated so that the pressure accumulates in the pump. When the pressure reaches a pre-determined value, the nozzle is switched to the opening position in order to allow air to flow into the tubeless tire from the cylinder at a high rate under a high pressure.

The present invention has been described through detailed illustration of the embodiments. Those skilled in the art can derive variations from the embodiments. The embodiments hence shall not limit the scope of the present invention defined in the claims.

1. (canceled)

2. The nozzle according to claim 13 wherein the shell comprises a shoulder formed between the first passage and the second passage for abutment against the valve so as to block the second passage from the first passage.

3. The nozzle according to claim 13 comprising a seal installed on the valve in order to block the first passage from the second passage.

4. The nozzle according to claim 13 comprising a spring for pushing the valve to the blocking position from the opening position.

5. The nozzle according to claim 4 wherein the valve comprises another reduced end on which the spring is installed.

6. The nozzle according to claim 13 comprising a joint connected with the shell for connection with a pipe.

7. The nozzle according to claim 6 comprising a seal installed on the joint.

8. The nozzle according to claim 6 wherein the joint comprises a reduced end for insertion in the pipe.

9. The nozzle according to claim 6 wherein the joint comprises a flange formed thereon for abutment against the shell.

10. The nozzle according to claim 6 wherein the shell comprises a third passage communicated with the second passage for receiving the joint.

11. The nozzle according to claim 13 comprising a cover for keeping the valve in the shell.

12. (canceled)

13. A nozzle comprising:
a shell comprising an exit passage, a first passage communicated with the exit passage, a second passage communicated with the first passage and an aperture communicated with the first passage, with the exit passage extending perpendicular to the first passage and to an extent, with the aperture extending parallel to and spaced from the exit passage;
a valve movable in the second passage between a blocking position for blocking the communication between the first and second passages and an opening position for allowing the communication between the first and second passages, the valve comprising a reduced end extending into the aperture through the first passage; and
a controlling device movable in the aperture between a first position corresponding to the blocking position and a second position for driving the valve by the reduced end to the opening position, with the controlling device including a portion extending out of the aperture and within the extent of the exit passages, wherein the controlling device comprises a cam put rotationally in the aperture, wherein the portion of the controlling device comprises a lever integrally formed as a single piece and extending from the cam perpendicular to the aperture, with the lever being pivotal about a plane parallel to and spaced from the first and second passages and perpendicular to the exit passage.

14. The nozzle according to claim 13 wherein the shell comprises a restraint integrally formed as a single piece with the shell and for restraining the lever in position relative to the shell by contacting and abutting with the lever integrally formed as the single piece with the cam.

15. The nozzle according to claim 13 comprising at least one seal installed on the cam.

16. The nozzle according to claim 13 comprising a bolt including a head and a threaded portion driven into the cam, with the head of the bolt of a cross sectional size larger than the aperture and contacting and abutting with the shell in order to keep the cam in the aperture.

17. (canceled)

18. A nozzle comprising:
a shell comprising an exit passage, a first passage communicated with the exit passage, a second passage communicated with the first passage and an aperture communicated with the first passage, with the exit passage extending perpendicular to the first passage and to an extent, with the aperture extending parallel to and spaced from the exit passage;
a valve movable in the second passage between a blocking position for blocking the communication between the first and second passages and an opening position for allowing the communication between the first and second passages, the valve comprising a reduced end extending into the aperture through the first passage; and
a controlling device movable in the aperture between a first position corresponding to the blocking position and a second position for driving the valve by the reduced end to the opening position, with the controlling device including a portion extending out of the aperture and within the extent of the exit passage, wherein the controlling device includes a rod rectilinearly movable in the aperture and a slope formed on the rod for driving the valve, wherein the portion of the controlling device comprises a button formed at an end of the rod, with the button having a cross sectional size larger than the aperture in order to keep the rod in the aperture.

19. The nozzle according to claim 18 comprising a bolt including a head and a threaded portion driven into the rod, with the head of the bolt of a cross sectional size larger than the aperture in order to keep the rod in the aperture.

20. The nozzle according to claim 19 wherein the shell comprises a shoulder formed between the first passage and the second passage for abutment against the valve so as to block the second passage from the first passage.

21. The nozzle according to claim 19 comprising a seal installed on the valve in order to block the first passage from the second passage.

22. The nozzle according to claim 19 comprising a spring for pushing the valve to the blocking position from the opening position.

23. The nozzle according to claim 19 comprising a cover for keeping the valve in the shell.
